(19) United States
(12) Patent Application Publication
(10) Pub. No.: US 2007/0100698 A1
(43) Pub. Date: May 3, 2007

(54) ADAPTIVE ADVERTISEMENTS AND ADAPTIVE ADVERTISING DISTRIBUTION SYSTEM

(75) Inventors: Jake NEIMAN, Concord, ON (CA); Ian Robert GADSBY, Toronto, ON (CA); Daniel Joseph FRASER, Toronto, ON (CA); Jeffrey David FINDLAY, Toronto, ON (CA); Andrew James KILPATRICK, Toronto, ON (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: ONESTOP MEDIA GROUP, Toronto (CA)

(21) Appl. No.: 11/613,467

(22) Filed: Dec. 20, 2006

Related U.S. Application Data
(63) Continuation-in-part of application No. 11/456,386, filed on Jul. 10, 2006.
(60) Provisional application No. 60/697,373, filed on Jul. 8, 2005.

(51) Int. Cl. G06Q 30/00

(52) U.S. Cl. 705/14

(57) ABSTRACT

An advertising system for displaying adaptive advertisements that can change the displayed content in response to external inputs can be used in public places such as transit stations, arenas, stadiums, retail stores, and squares. The advertising system can also be deployed in transit vehicles. The advertisements make use of a decision engine to select from a plurality of advertising scenarios to generate the content that is rendered on displays. The system has a processor that executes the decision engine and provides the decision engine with the external inputs, such as time of day, weather conditions and forecast, current, past or next transit station, required to select one of the stored advertising scenarios. These input scenarios can be either stored by the system or obtained in real-time. A system for distributing advertisement content to displays for playback based on the correlation between the attributes of the Content, attributes of the displays, and other factors.

### CROSS REFERENCE TO RELATED APPLICATIONS

This application is a continuation-in-part of Ser. No. 11/456,386, filed Jul. 10, 2006 which is incorporated herein by reference.

### FIELD OF THE INVENTION

The present invention relates to displaying information, such as advertisements. More particularly, the invention relates to video display of adaptive advertising and notices.

### BACKGROUND OF THE INVENTION

Conventional advertising displays are used to provide a marketing message to an audience. One such example of an advertising display is a billboard or poster advertisement. This advertisement is displayed for a fixed period of time in a defined place. The rates charged for the advertisement are most commonly related to the audience reached by the advertisement, the length of time that it will be displayed and the location of the advertisement. In an effort to share a single advertising space, numerous different techniques have been employed to essentially time-share a single advertising location.

Growing in popularity for a number of different advertising locations is the use of a video display. Video displays are often found in transit systems, including in subway cars, train cars and other transit vehicles, at transit platforms, at bus stops, and at other mobile and fixed locations. These displays are often networked to a central control system, although they can also be standalone units that are programmed individually. Advertising content can be displayed on the screens for timed intervals, and can include motion and animation as well as statically displayed images. The displays can effectively provide advertisers with the ability to display television style advertisements in public spaces.

The displayed content is typically stored on a storage medium and retrieved and displayed according to an advertisement schedule. The retrieval and rendering of the advertisement is often done using a conventional processor. The content displayed by the display is often static, in the sense that the playback is governed by a playback list, so that over a length of time, the same advertisements are displayed creating a static loop. This loop does not vary until updated by an operator.

In conventional transit systems and retail environments, display units are either static billboards, or are displays that provide commuters or retail customers with rudimentary graphics and text based messages. On some more sophisticated systems, a pre-recorded (or pre-scheduled) video feed is looped through displays. This pre-recorded video feed is another example of static content, as after being loaded, the video feed defines a static list of the content displayed.

In interactive environments, such as the World-Wide Web on the Internet, advertising can be tailored to an audience by allowing a remote advertising server to select advertisements based on information known about the viewer, typically stored in or referenced in a cookie, or on information, such as what a user is searching for. These advertisements are then sent to a user's local computer system where they are rendered onto the user's display. This provides a degree of adaptability in on-line advertising that is lacking in conventional advertising environments, however, information about the local environment of the user viewing the advertisement cannot be accounted for when selecting the advertisement. Conventional advertising could greatly benefit from the ability to tailor advertising to variable factors in the same way that online advertising can be adapted, while providing the further ability to include local input values in the decision process.

Therefore, it is desirable to provide a public display system for displaying advertisements and other notices as a function of variable criteria.

### SUMMARY OF THE INVENTION

It is an object of the present invention to obviate or mitigate at least one disadvantage of previous advertisement and information dissemination systems.

In a first aspect of the present invention, there is provided a system for displaying adaptive advertisements. The system comprises a display, a playlist and a processor. The playlist stores an adaptive advertisement containing a plurality of playback scenarios and a decision engine. The processor receives at least one input value, determines advertising content, for the adaptive advertisement based on evaluation of at least one input variable according to a criterion of the decision engine, and renders the determined advertising content onto the display.

In embodiments of the present invention, the system further includes a secondary display, and one of the display and the secondary display is selected from a list including a cathode ray tube display, a liquid crystal display, a plasma display and an electronic paper display. The system can also include a transceiver for connecting the processor to a central control system, while the processor can include means for receiving a playlist from the central control system through the transceiver, which can be a wired or wireless transceiver.

In a second aspect of the present invention, there is provided an adaptive advertisement. The advertisement comprises a plurality of playback scenarios and a decision engine. The decision engine receives a set of input values, selects at least one playback scenario in accordance with the received set of input values, and provides as output, advertising content determined in accordance with the at least one selected playback scenario.

In embodiments of the second aspect of the present invention, one of the playback scenarios has at least one associated criteria, and the decision engine includes selection means for selecting the at least one playback scenario by evaluating the input values in view of the at least one associated criteria. In other embodiments, the set of input values includes at least one externally measured input value, which is selected from a list including current weather conditions, UV ratings, and a current time. In other embodiments, the set of input values is selected from a list including a time, a date, a location, a news feed, a sports score feed, a stock ticker feed, current weather conditions, forecast weather conditions, current traffic conditions and a manual input. The location can be an absolute geographical location, a location relative to a specified venue and a location relative to a transit stop.

In a third aspect of the present invention, there is provided a method of selecting an adaptive advertisement. The method comprises evaluating an input value in view of at least one criterion; selecting a playback scenario in accordance with the evaluation of the input value; and rendering the selected playback scenario to a local display.

According to another aspect of the present invention, there is provided a method of distributing advertisements to displays comprising: evaluating content attributes associated with a plurality of advertisements; evaluating display attributes associated with a plurality of displays; correlating said attributes to determine matches between said content attributes and display attributes; and distributing advertisements to one or more displays for play based on said correlation. According to an embodiment, adaptive advertisements, are so distributed.

According to another aspect of the present invention, there is provided a system for distributing advertisements to displays comprising: means for evaluating content attributes associated with a plurality of advertisements; means for evaluating display attributes associated with a plurality of displays; means for correlating said attributes to determine matches between said content attributes and display attributes; and means for distributing advertisements to one or more displays for play based on said correlation.

According to another aspect of the present invention, there is provided a computer program product stored in machine readable medium containing software instructions, which when executed by a processor of a system for distributing display advertisements, causes said processor to execute the steps of evaluating content attributes associated with a plurality of advertisements; evaluating display attributes associated with a plurality of displays; correlating said attributes to determine matches between said content attributes and display attributes; and distributing advertisements to one or more displays for play based on said correlation. According to an embodiment of the invention such a system for distributing display advertisements comprised a general purpose computer with a network connection.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a system of the present invention;

FIG. 2 is a block diagram illustrating an embodiment of an adaptive advertisement of the present invention;

FIG. 3 is a block diagram of an embodiment of the present invention;

FIG. 4 is a flowchart illustrating a method of the present invention; and

FIG. 5 is a block diagram of an another embodiment of the present invention.

### DETAILED DESCRIPTION

Generally, the present invention provides a method and system for displaying adaptive content such as advertisements through a communication system having a display. The communication system can be deployed in any number of areas including public transit environments, both on transit vehicles and at platforms, stations, or bus shelters or in elevators, and at other locations such as in retail, hospitality and public environments. The displays of the adaptive advertising system can be coupled with storage and processing facilities and can communicate with a central control system by use of a standard communications network, such as the Internet, or suitable alternatives. In one embodiment, a private wired and wireless network is employed to connect the displays to the central control system to provide for the distribution of advertising content to the displays.

The system can provide advertising content, and other related information to the display system using messages that may be formatted using extensible mark-up language (XML).

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

At present, advertisers are required to design a single advertisement for use on a display. This advertisement is delivered to a storage array in communication with the display, and at fixed intervals, the advertisement is played. To provide variety, advertisers can create multiple advertisements and insert each of them into the rotation. This could allow different advertising “spots” to target different demographics. However, advertisers are still, in essence, constrained by static play lists.

In the present invention, a display is intelligently controlled. The displays may be autonomous, or can be centrally controlled. Each display in a network, or a standalone display, is programmed to allow a more dynamic advertising environment. In prior art systems, a complete video loop is often created and is uploaded to the display, this loop is then played. Customizing advertisements for external conditions requires creating a new video loop and transferring the video loop to the display. This is not feasible due to the workload involved in recreating new video loops (or animations) and distributing them to various displays if the number of input variables exceeds a small number.

Whereas prior art advertisements were static elements, the present invention provides adaptive advertising. An embodiment of the invention utilizes an adaptive advertisement structure which can be viewed as a container having a plurality of playback scenarios. Inputs are provided to the adaptive advertisement, and on the basis of the inputs, the playback scenarios and advertising content are adaptively adjusted.

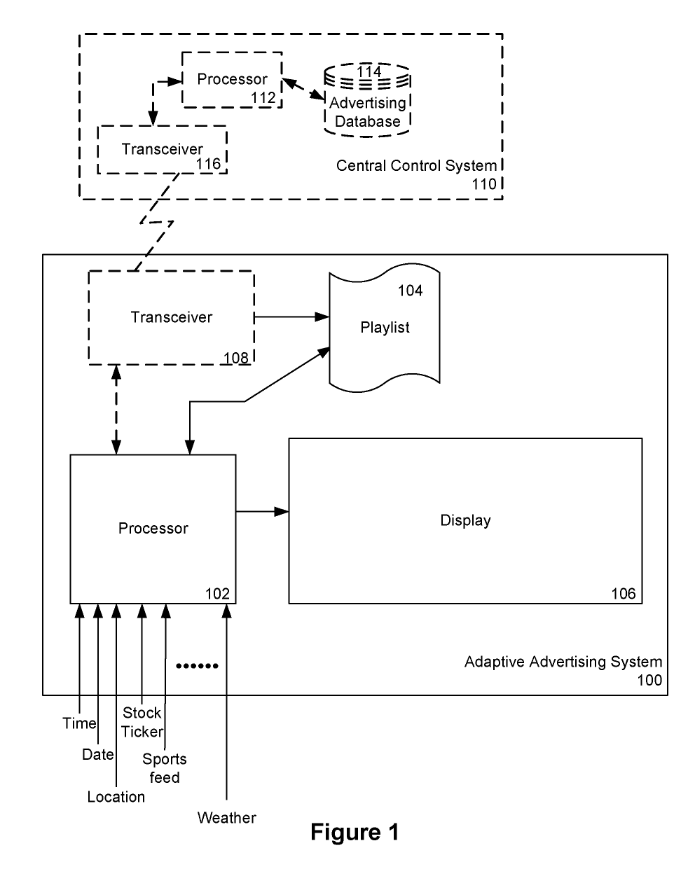

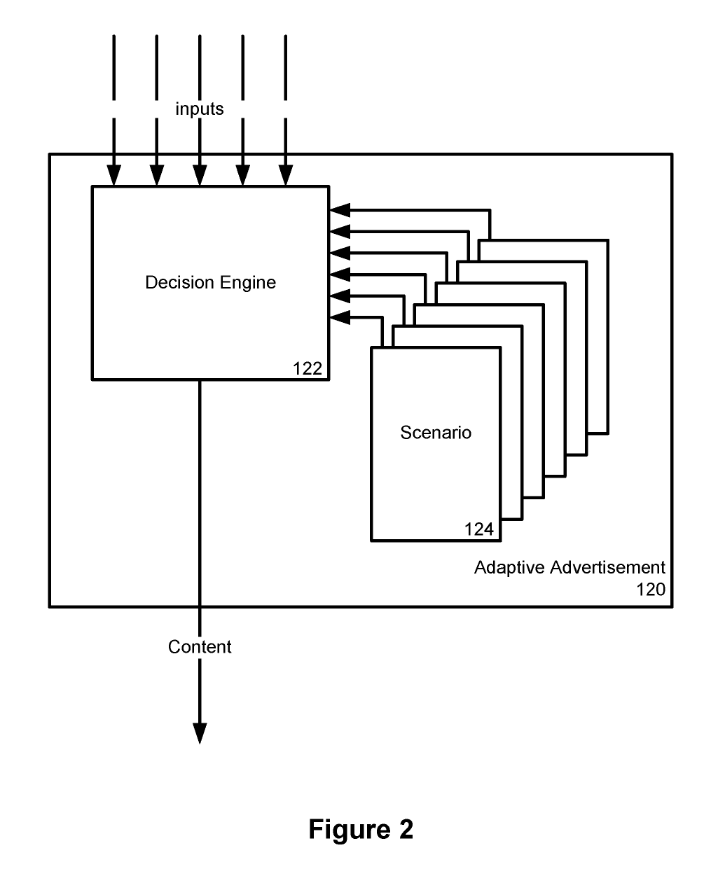

FIG. 1 illustrates a system of the present invention, where the adaptive advertising system 100 has a processor 102 capable of receiving a plurality of inputs. Processor 102 reads playlist 104, and renders advertisements contained in playlist 104 to display 106. Playlist 104 contains at least one adaptive advertisement. When processor 102 receives the adaptive advertisement, it provides a set of input values to the advertisement. Processor 102 can provide all the inputs it receives to the advertisement, allowing the advertisement to determine which inputs are relevant, or can obtain a list of required inputs from the advertisement and then provide only those inputs. Not all the inputs need be either external or live. An exemplary embodiment of an adaptive advertisement is presented below with reference to FIG. 2.

In some embodiments of the adaptive advertising system 100, a transceiver 108 is employed to connect to a central control system 110. The central control system 110 includes a processor 112, an advertising database 114 and a transceiver 116 for connecting to the adaptive advertising system transceiver 108. The central control system 110 can provide system 100 with playlist 104. The illustration of the use of transceivers 108 and 116 to facilitate communications will be understood to include intermediate nodes including portable programming nodes allowing a manual update of the adaptive advertising system 100 using a direct wired or wireless connection to a portable programming interface.

FIG. 2 provides a block diagram of an exemplary adaptive advertisement 120. The adaptive advertisement 120 can be embodied in a software or data structure that includes a decision engine 122 and a plurality of playback scenarios 124. These playback scenarios can be either major or minor changes to an advertisement. An advertisement can be made modular, so that it can be rendered against a number of different backgrounds. In such a case, the different backgrounds can be selected as different playback scenarios. In other cases, text displayed in the advertisement can be made modular, allowing different messages to be treated as different scenarios. Other elements in an advertisement, such as video, animations and a price point can all be considered as different playback scenarios.

When the adaptive advertisement 120 is executed by processor 102, decision engine 122 is provided with a set of inputs from processor 102. These inputs are used by decision engine 122 to determine the playback scenario or scenarios that are used in the construction of the content that will be rendered by processor 102 onto display 106.

Decision engine 122 evaluates the set of inputs in view of at least one criterion stored in the decision engine 122. Based on the evaluation of the set of inputs, the decision engine 122 selects a set of playback scenarios from the scenarios 124 that are contained in the adaptive advertisement 120. The inputs used as criteria in determining the playback scenario or scenarios used in the construction of the content can include information obtained from any number of inputs including attributes for the display: for example the city that the display is situated in, the region that the display is situated in, the absolute location of a display, the relative location of the display to a position in a transit system, the relative location (i.e., the proximity) of the display to a profiled amenity or venue (such as a restaurant, coffee shop, other such retail establishment, tourist attraction, or other similar amenities); and external factors, for example, the time of day, the date, weather information including both present and predicted weather conditions and UV measurements, sports scores, stock market results, traffic conditions and any of a number of other such external factors.

It may not be possible for processor 102 to obtain real time inputs for each time an adaptive advertisement is displayed. As a result, processor 102 can buffer input values if they are not readily available, or if they are not available in real-time, so that it can provide them to decision engine 122. The inputs can also be manually controlled, so that an operator can provide a new price point over a manual input, allowing the adaptive advertisement to change an advertised price.

It should be noted that it is possible for the decision engine 120 to determine that no playback scenario is selected, allowing the advertisement to be effectively skipped or pulled from rotation. Thus, it would be possible to design an adaptive advertisement that was played only under certain circumstance, such as an advertisement for tickets to a playoff game for a sports team that would only be played if the team had not been eliminated from the playoffs.

When decision engine 122 determines the playback scenario, and provides content to be rendered, the content can be in any one of a number of formats. In a presently preferred embodiment, the content is provided as an XML data structure that can contain, text, video, and animations. The XML data structure is then rendered by processor 102 onto display 106. Processor 102 preferably includes a Macromedia Flash™ rendering engine that can combine the animation, text and video into an integrated advertisement. One skilled in the art will appreciate that any number of other rendering engines can be used, and that the invention is in no way limited to the use of Flash™ rendering engines.

In an alternate embodiment, individually created advertising content elements are stored in an advertising database with a set of associated criteria. Processor 102 is provided with a playlist 104, that provides criteria for the selection of content stored in advertising database. The processor 102 evaluates the received inputs in view of the specified criteria, including the last time that a particular advertisement played, determines the advertisement to select from the advertising database. The selected content is then rendered by processor 102 onto display 106.

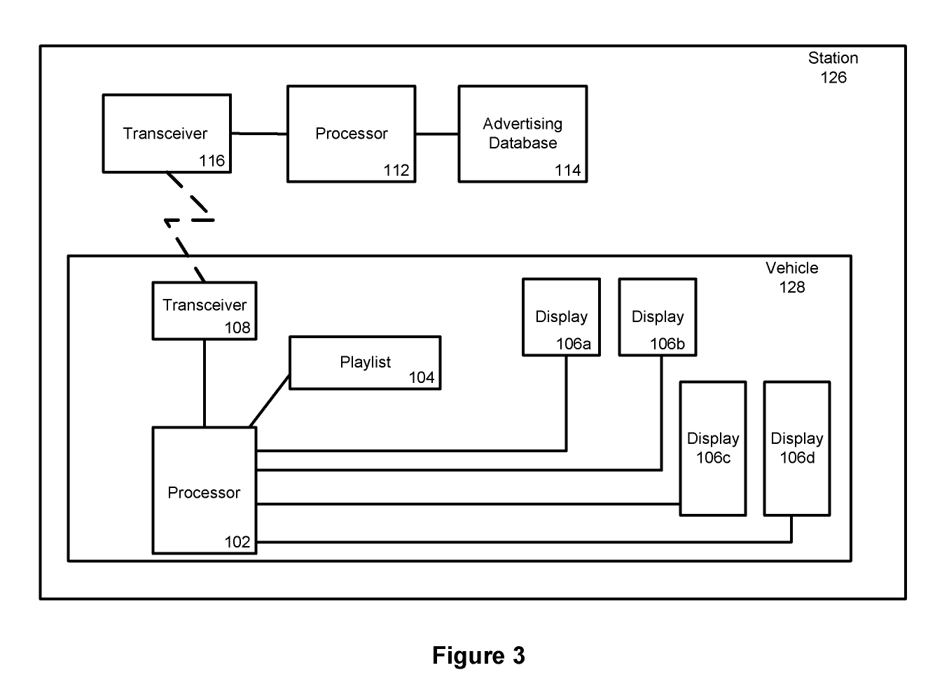

FIG. 3 illustrates an embodiment of the present invention for use in a transit system, where displays are provided on transit vehicles. In transit systems, the adaptive advertising system is often not served by always-on connections to the central control system. The following discussion refers to the connection to the network of a system on a train while in a station, but is equally applicable to other transit vehicles at various network connection points.

Station 126 is equipped with advertising database 114, processor 112 and transceiver 116. Transceiver 122 is used to connect to the advertising system on transit vehicle 128. The connection to the unillustrated central control system can be using wireline and/or wireless means as are known in the art. The playlist 104 is received at transceiver 108 and can be stored locally. Transceiver 116 can transmit data stored in advertising database 114 to transceiver 108 disposed on transit vehicle 128 when transit vehicle 128 is in communication range, as it would be while in station 126. Each transit vehicle 126 can contain a plurality of monitors including Liquid Crystal Displays (LCD) 106a and 106b, staggered along the transit vehicle to provide good viewing for the users. Secondary e-paper displays 106c and 106d can also be used to display ancillary advertising material. Upon transit vehicle 128 arriving at station 126, transceiver 116 transmits the playlist 104 stored in advertising database 114 to transceiver 108. The playlist 104 is then handled by processor 102 as described above.

Processor 102 can track how an adaptive advertisement 120 was rendered the last time that it was played, allowing decision engine 122 to avoid selecting the exact playback scenario 124 that was previously played, to give the appearance of a variety of advertisements, if so desired. Furthermore, external factors such as the time of day can be used by the decision engine 120 to select a playback scenario 124, so that an advertiser can have different advertising content shown during a morning and evening commute. The date can also be considered a factor. This allows adaptive advertisement 120 to be preloaded with an advertising campaign as one of the plurality of playback scenarios, and decision engine 120 will prevent this campaign from being launched prior to a given date by use of the present date as an input criteria used to select the playback scenario 124. The date can also be used to allow scenarios 124 to be designed for use around events such as summer long weekends, and selected by decision engine 120 to be displayed only during those times, while other content is displayed at other times. Regional or city considerations can be taken into effect in the advertising selection to, for example, allow a sporting goods store to create advertising specific to different sports markets. This can also be tied in with the progress of a sporting team based on sports scores or other such external inputs.

The location of the display can also be used to determine the selection of scenarios for use in the advertising content, allowing advertisers to create advertisements that indicate the presence of a restaurant or other such service for a given location. On mobile installations, such as transit vehicles, the location of the display can be obtained using sensors, such as a Global Positioning System (GPS) receiver that provides a geographic location that can be used as a selection factor for advertising scenarios. Weather forecasts, including UV ratings, humidity indices, and extreme weather warnings, can be used to determine a particular playback scenario that a store may wish to display, allowing for example a department store to advertise umbrellas when the weather calls for rain and sunblock when the UV rating is high.

One skilled in the art will readily appreciate that decision engine 120 can make use of the inputs provided to it to make any number of other decisions regarding selection of playback scenarios. Other inputs that may be used can include, but are not limited to, security ratings such as terrorist alerts, Amber alerts and other child safety warnings, traffic congestion reports and manual inputs.

The use of an adaptive advertisement 120 having a plurality of playback scenarios allows playlist 104 to be preloaded with a number of modular advertising content elements. This preloading can be done at fixed intervals and at convenient times, such as during off hours in a transit system, or when a vehicle is in a service depot, although short playlists can also be transmitted wirelessly to advertising systems in vehicles as they pass through stations.

Although reference has previously been made to the use of the present invention on a transit system, it should be noted that the adaptive advertising system 100 and the adaptive advertisement 120 can be used in any number of different environments including retail, corporate, warehouse and hospitality environments. It should be noted that suitable displays can be located in bus shelters and other outdoor media properties. The following example makes reference to the adaptive advertising system 100 of FIG. 1 and the adaptive advertisement of FIG. 2.

An advertising system 100 in a commercial environment is in use during the hours that the commercial space is open to the public. It can be connected to central control system 110 through a wireline link between transceiver 108 and transceiver 116. During off-hours, or throughout the day, the advertising system 100 is updated to display a new playlist containing an adaptive advertisement. One skilled in the art will note that although in certain embodiments it may be preferable to perform updates during off-hours, systems of the present invention can be updated without impeding playback. This playlist is stored on a local storage medium (not illustrated). During operational hours, the adaptive advertisement is read. The processor 102 executes the instructions in adaptive advertisement 120. Prior to the content being rendered onto display 106 the decision engine evaluates the provided set of inputs to select a playback scenario defined by criteria in the adaptive advertisement 120. One skilled in the art will appreciate that a playlist can contain a plurality of adaptive advertisements, or a single adaptive advertisement without departing from the scope of the present invention.

For example, the criteria can include the latest weather conditions and a forecast. This information can be live or it can be stored on a local storage medium. Decision engine 120 can then select a playback scenario according to the current outdoor temperature. As an example of this scenario, if the advertiser is a food chain selling hot and cold beverages, the content provided by the adaptive advertisement can advertise for cold beverages on a hot day, while a hot beverage scenario can be selected on a cold day. Based on the location of the display 106, the decision engine can also select a playback scenario that has a background map to indicate the closest location of the restaurant.

In addition to current outdoor temperature and present location, the criteria by which a scenario can be selected include external factors discussed above such as time of day, current date, city, region, previous and current transit station, current and forecast sky conditions, forecast temperature, and also other factors such as custom data updatable by a client, or the number of times the advertisement has played in a predetermined time period, etc.

Adaptive advertisement 120 can include several advanced Flash™ templates that dynamically build on-screen layouts and manage the playback of scenarios and content. These Flash™ templates can be provided to processor 102 as part of the content output by the adaptive advertisement 120 for rendering. In a presently preferred embodiment, the content is provided as an extensible mark-up language (XML) file that includes information such as which graphical components to display on the screen and where they should be placed in the layout.

The dynamic content technology of the present invention allows for easy advertisement scheduling and allows for maximum power and flexibility for advertisers. Advertisements can be developed with Flash™ or with a combination of Flash™ and video overlay and allows advertisers to combine the power of computer programming with the traditional visual elements of a television advertisement spot. The present invention can use communication systems to access real-time and real-world information in order to customize advertisements in accordance with, for example, the time of day and the location of the display.

One skilled in the art will appreciate that when processor 102 controls a plurality of displays such as display 106a-d, as illustrated in FIG. 3, each of the displays can receive its own rendered data stream. Furthermore, each of the multiple displays need not use the same display technology. For example, in a transit vehicle, a first display can be a liquid crystal display (LCD), cathode ray tube (CRT) or a plasma screen display, while secondary displays could be electronic-paper displays. The first display would be used to display motion and animated advertisements, while the e-paper displays could provide auxiliary advertising related to the content on the first display. One skilled in the art will also appreciate that other display technology, including but not limited to cathode-ray tubes can also be used without departing from the scope of the present invention.

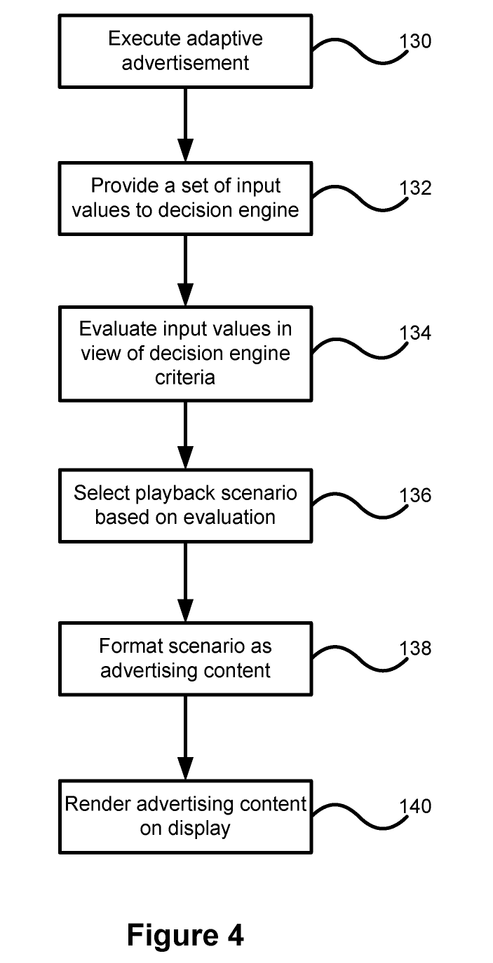

FIG. 4 is a flowchart illustrating a method of the present invention. In step 130, adaptive advertisement 120 is received and executed by processor 102. Processor 102 provides a set of input values to decision engine 122 in step 132. Processor 102 can provide all its input values, or a subset of input values to decision engine 122, depending on the implementation of the system and method. These inputs can be obtained in real-time, or can be buffered. This allows a mobile adaptive advertising system 100 to obtain input values intermittently and store them for later use. Decision engine 122 includes at least one criterion for selecting playback scenarios. The provided set of input values is evaluated in view of at least one criterion in step 134. On the basis of the evaluation of the input values, at least one playback scenario is selected in step 136. The selected playback scenarios are provided as output advertising content, preferably after they have been formatted in step 138 in a defined format, such as an XML data structure. This output advertising content is then rendered by processor 102 into display 106 in step 140.

According to an embodiment of the invention, the decision making relating to determining the content to be displayed at a particular location during a particular time as described above includes an evaluation of attributes associated with the Content, an evaluation of attributes of the display (e.g. location) and an evaluation of other factors, such as time of day, weather and other inputs. Such evaluations can be made either locally at each display or station, or centrally, for example by the central control system 110, or by some combination of the two.

We will now discuss an embodiment of the invention directed to intelligent content distribution. According to this embodiment, each display (or possibly group of displays) is given a profile which includes a set of one or more attributes. Attributes include: location and demographic attributes. For example location attributes can include absolute location information (e.g., gps co-ordinates); type of location (e.g., an indication that the screen is within a subway car, airport or hotel); or relative location or proximity information (for example, located within a specified distance from a specified venue. The specified venue can be either a general type and/or specific brand, for example a particular retailer, service provider or bank machine, a transit hub/airport, attraction, etc.). Screens within a building or on a subway train can be considered a group, and given a common profile.

Multiple attributes can be assigned to each screen or Group in order to more precisely position relevant content.

Of course the content itself must be assigned attributes for ascertaining its placement (i.e. assignment for playback on selected displays under particular circumstances). Therefore each content segment (advertisement, Public service announcement, or otherwise) is assigned placement attributes. Some of these placement attributes are assigned to content segments consistent with the way attributes are assigned to screens. In other words the inputs relate to attributes based on location; attributes relating to content (e.g., advertisements for establishments, or for services and/or types of goods, possibly available near a given display or group of displays, etc); and other external factors (e.g., temperature, time of day, season, etc.—for example advertise an ice cream store in a heat wave, nearby restaurants during lunch, a nearby florist or gourmet chocolate store on valentines day, etc.).

In addition, the content is assigned play parameters for determining the timing and frequency of playback for a particular campaign. For example, a particular advertising campaign may have a parameter defining its playback frequency during a time period preceding an event. For example a trailer for an upcoming movie with a large advertising budget may have parameters for hourly placements during the week prior to, and following its opening. These parameters are then provided with rankings and tolerances to assist in determining which of many advertisements are to be displayed across which displays.

For example, a chain of Ice Cream stores may provide attributes which indicate the location of all of their stores, and the situations where they wish particular ads to be displayed (e.g. displaying ads on displays near colleges and high schools on hot afternoons within a specified distance of one of their stores). Such attributes are then correlated with display attributes and external factors to determine suitable matches for displaying their advertisements.

A centralized approach can be beneficial for situations where a large number of displays are distributed in different locations. In such a centralized approach, the processor 112 of the central control system 110 would execute a plurality of adaptive advertisements 120. It would also evaluate the inputs and correlate the attributes and external factors to determine which content to distribute to the various displays.

Embodiments of the invention distribute content to displays for playback based on a correlation between the attributes of the Content, attributes of the displays, and other factors. The other factors include the input values described above, and can in addition include:
Priority of an advertising client and/or particular content. For example, an operator can assign high priorities for ad placements for repeat clients or clients with large advertising budgets.
Demand for particular locations and/or timeslots. For example, there may be limited or no inventory available on a display or Group of displays as higher priority content has already been allocated to available timeslots;
The budget allocated for a particular content segment (if it's a paid content segment) and the price to be charged.
Restrictions to playback. For example, an ad for a hotel chain should not be played in the lobby of a competing brand's location.
The playback duration and desired frequency for a given Content Segment, as well as the length of time a particular advertising campaign featuring a given Content Segment is expected to last. For example a client may pay for an advertising campaign featuring a 20 second advertisement for a one time concert to be played daily for the month prior to the concert, then hourly for the week preceding the day of the concert, at which point the campaign will end.

For example, embodiments of the invention may not distribute particular content to displays with a strong correlation based on the following factors:
Insufficient budget to pay for the Content Slot (e.g., the budget would have been exhausted within 3 hours if distributed to the all displays with high correlations, and the purchaser has requested a 5 week campaign);
a time slot on a display which matches the criteria specified by the advertiser is too expensive due to a premium charged for high traffic areas and/or times.

Embodiments of the invention can provide a play forecast for a content segment/advertiser based on the characteristics of the advertiser, and content segment attributes that are entered into the system. The advertiser is able to review the play forecast, and enable the advertiser to make additional customizations and changes. For example, responsive after the play forecast is generated, the placement attributes can be modified and then another play forecast is generated for customer review. This is a “Quality Assurance” process which enables the advertiser to review where their ads will play, for how long, and the anticipated audience reach, etc. prior to approving and purchasing a campaign. Furthermore, embodiments of the invention can allow an advertiser to purchase an advertising campaign online by inputting their preferences/attributes and having the system compute/recommend a content distribution scenario automatically. This can reduce or even eliminate the need for any human involvement with the purchase process.

One skilled in the art may envision and example whereby an advertiser would input their $50,000 budget, select the types of networks (retail, hospitality, transit, etc.) and then a duration for the campaign. Further embodiments would allow more specific information to be added—for example, a desire for geographic placement 1 km from a location, and to only play in urban centres in western North America. With these attributed loaded, as well as the type of product (used for product separation) and restrictions the placement decision engine would schedule the ad to play on multiple screens on multiple networks. The placement of these ads would be reported back for verification to the media buyer. An embodiment of the invention could allow further modifying the placement attributes and then generating a revised play forecast for customer review. Once the plan is verified, the system books the ad for play out and eventual billing.

Embodiments of the invention track the actual display of the content, based on the matched attributes, and generate a display report. Such a report can include such items as:
When the Content played, where it played and how much that play cost
details on exactly how the total budget was allocated
the basis of determining how the content was distributed.

An embodiment of the invention allows a web-based system to allow a client to log in to view their particular ad contract, and the results of it's playout. For example, the client can see when the ad played, where the ad played, and the associated costs with that ad play. As well as giving a user the ability to view how budgeted amount decreases as the play outs happen, an embodiment of the invention provides the ability for a media buyer to ‘top up’ their spend in order to alter or prolong a campaign.

At times, an inventory slot may be ‘booked’ or filled. By inventory slot, we mean a place (i.e., a display) and timeslot in which an ad can be played. An embodiment of the invention allows a buyer to place a reservation in for an inventory slot in case it becomes free again, for example, due to a cancellation or a ‘bidding war’ ensuing between rival media buyers. In some embodiments, particularly when adaptive advertisements are used, a buyer may not know they have received a coveted spot until moments before the ad plays, as real time criteria can determine which of several possible ads are actually played out at any given time.

Email notification can be added to the automated system to let buyers know when budgets are exhausted, or are approaching exhaustion. One skilled in the art can should appreciate that other factors that can trigger email notifications, including user defined lists set by the buyer.

Embodiments of the invention allow clients (e.g., advertisers) to login in real-time to see the status of a campaign. Such a client can then request changes or revision, and can renew, or allocate more funds to the account online. Conversely embodiments of the invention automatically send messages (e.g., Email or SMS, etc.) to advertisers that their campaign is running out of funds or otherwise coming to an end.

Embodiments of the invention will also adjust the price of a content segment for a given display or group based on supply and demand criteria. This enables the operator to charge a premium or offer a discount for certain displays and/or timeslots. This can be based on anticipated demand or previous cost data. For example if a transit group (e.g., a group of displays operating on a subway line) is sold out at $50 per ad in a first month, the system will identify the significant demand for transit group, and therefore increase the price charged from $50 to $60 in a subsequent month. Or, if not adjusted automatically, embodiments of the invention can provide recommendations and feedback to a system operator.

For example an operator can deploy displays or groups of displays at locations owned by third parties. The operator can of course pay a fixed rent charge per display. Alternatively One useful feature which can be incorporated according to embodiments of the invention is a revenue sharing scheme, whereby the operator and the landlord share the advertising revenues. For example a chain of hotels may deploy a display in the lobbies of its hotels, for a set share of the advertising revenues. The system will track the revenue generated in each hotel (or all of the hotels) and automatically calculate how much revenue each hotel location (for example, in the case of a franchisee) or the entire hotel Network is owed. The system can also provide the appropriate documentation and evidence to support the revenue share (based on the above described audit trail reports). Thus each hotel will receive an accurate revenue share and associated report based on the actual dollar amount generated by that real-estate.

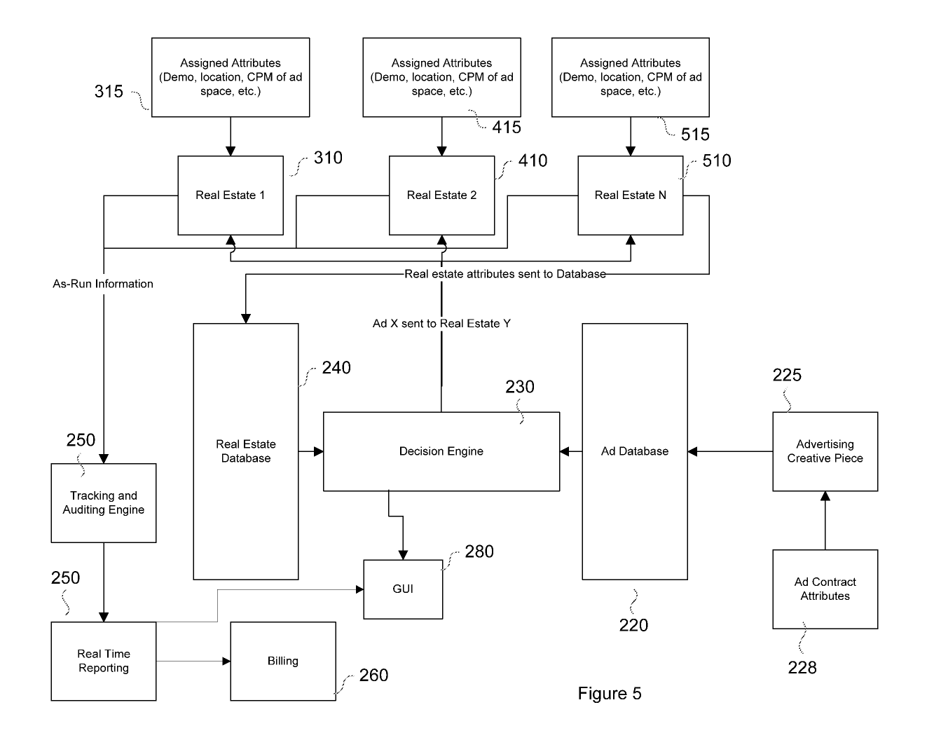

FIG. 5 is a block diagram of the system according to an alternative embodiment of the invention which includes a centralized decision engine 230 for distributing adds to remote displays, for example, display 310 located at Real Estate 1; display 410 located at Real Estate 2; and display 510 located at Real Estate N. It should be noted that a group of displays may be located at any given Real Estate location. Each real estate location has an associated set of assigned attributes, for example demographics, location, cost per minute of ad space, etc., as described above. Thus display 310 has assigned attribute 315; display 410 has assigned attribute 415; and similarly display 510 has assigned attribute 515. As discussed above some of these attributes may be fixed and some may include data collected from the real estate location for example, temperature, as discussed above. These attributes are then sent to a real estate database 240. Each ad includes an advertising creative piece 225 containing the media to be displayed, as well as ad contract attributes 228. Ad contract attributes can include content attributes associated with the advertisement as well as other factors.

The decision engine 230 correlates the attributes of the displays with the ad contract attributes and other factors to determine were and when the ads are displayed.

The system also includes a tracking and auditing engine which collects information as to which ads were displayed at which locations at which time. In the embodiment as shown this information is tracked directly from the real estate locations although it should be understood that the information can be collected from the decision engine directly when Ad X is sent to Real Estate Y. The tracking and auditing engine provides ad placement reporting 260, possibly in real time, and billing features 270. Embodiments of the invention also include an graphical user interface 280 for allowing a user to view a play forecast or to view the status of a campaign as described herein. The graphical user interface 280 also allows an operator to enter or view cost or other data.

It should be understood that the system can be implemented on a general purpose computer with the different engines and databases representing appropriate software and data blocks. Alternatively, a distributing system can be implemented.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A system for displaying adaptive advertisements comprising:
a display;
a playlist storing an adaptive advertisement containing a plurality of playback scenarios and a decision engine; and
a processor for receiving a set of input values, for determining advertising content, for the adaptive advertisement based on evaluation of the set of input values according to a criterion of the decision engine, and for rendering the determined advertising content onto the display.

2. The system of claim 1 wherein the set of input values includes at least one externally measured input value.

3. The system of claim 2 wherein the at least one externally measured input value includes the location of the display.

4. The system of claim 1 further including a transceiver for connecting the processor to a central control system.

5. The system of claim 4 wherein the processor includes means for receiving a playlist from the central control system through the transceiver.

6. The system of claim 4 wherein the transceiver is a wireless transceiver.

7. The system of claim 4 wherein the transceiver is a wired transceiver.

8. An adaptive advertisement comprising:
a plurality of playback scenarios; and
a decision engine for receiving a set of input values, for selecting at least one playback scenario in accordance with the received set of input values, and for providing as output advertising content determined in accordance with the at least one selected playback scenario.

9. The adaptive advertisement of claim 8 wherein one of the playback scenarios has at least one associated criteria, and wherein the decision engine includes selection means for selecting the at least one playback scenario by evaluating the input values in view of the at least one associated criteria.

10. The adaptive advertisement of claim 8 wherein the set of input values includes at least one externally measured input value.

11. The adaptive advertisement of claim 10 wherein the at least one externally measured input value is selected from a list including current weather conditions, UV ratings, and a current time.

12. The adaptive advertisement of claim 8 wherein the set of input values includes an input value selected from a list including a time, a date, a location, a news feed, a sports score feed, a stock ticker feed, current weather conditions, forecast weather conditions, current traffic conditions and a manual input.

13. The adaptive advertisement of claim 12 wherein the location is an absolute geographical location.

14. The adaptive advertisement of claim 12 wherein the location is a location relative to a specified venue.

15. The adaptive advertisement of claim 12 wherein the location is a location relative to a transit stop.

16. A method of distributing advertisements to displays comprising:
evaluating content attributes associated with a plurality of advertisements;
evaluating display attributes associated with a plurality of displays;
correlating said attributes to determine matches between said content attributes and display attributes; and
distributing advertisements to one or more displays for play based on said correlation.

17. A method as claimed in claim 16 further comprising evaluating other factors, and said correlating step determines said matches which also satisfy said other factors.

18. A method as claimed in claim 17 wherein said other factors include at least one externally measured input value.

19. A method as claimed in claim 17 wherein said other factors include any of:
a. a priority for an advertising client;
b. the demand for particular timeslots;
c. the demand for particular locations;
d. the budget allocated for ad placement; or
e. the playback duration and desired frequency for a given Content Segment.

20. A method as claimed in claim 17 further comprising, prior to said distribution step, generating a play forecast of an advertising campaign listing where and when content for a particular advertiser will be displayed, so that said advertiser can determine whether to accept said advertising campaign.

21. A method as claimed in claim 22 further comprising, responsive to said generating step, modifying the placement attributes and then generating a revised play forecast for customer review.

22. A method as claimed in claim 17 further comprising, generating a display report of an advertising campaign listing where and when content for a particular advertiser was displayed.

23. A method as claimed in claim 17 further comprising determining the price of an advertising campaign.

24. A method as claimed in claim 17 wherein said advertisements are adaptive advertisements.

25. A method as claimed in claim 17 further comprising, prior to said evaluating steps, receiving input from an advertiser defining said content attributes and advertising budget.

26. A method as claimed in claim 17 further comprising, generating a report revenue of advertising revenue generated for particular displays to be used for revenue sharing.

27. A method as claimed in claim 17 wherein said other factors include a determination of whether particular inventory slots have been reserved.

28. A method as claimed in claim 25 further comprising receiving revised input from an advertiser.

29. A method as claimed in claim 25 further comprising sending a notification to said advertiser.
